(19) United States
(12) Patent Application Publication
(10) Pub. No.: US 2022/0380635 A1
(43) Pub. Date: Dec. 1, 2022

(54) Silicon-Based Coating Composition, and Silicon-Based Release Film Comprising Same

(71) Applicant: LG Chem, Ltd., Seoul (KR)

(72) Inventors: Jun Hyoung Park, Daejeon (KR); Jihye Jung, Daejeon (KR); Kwang Su Seo, Daejeon (KR)

(73) Assignee: LG Chem, Ltd., Seoul (KR)

(21) Appl. No.: 17/765,685

(22) PCT Filed: Jul. 20, 2021
(86) PCT No.: PCT/KR2021/009317

§ 371 Date: Mar. 31, 2022

(30) Foreign Application Priority Data
Jul. 22, 2020 (KR) 10-2020-0090770

(51) Int. Cl. C09J 7/40; C09J 7/25; C09J 7/20

(52) U.S. Cl. CPC C09J 7/401; C09J 7/255; C09J 7/201; C09J 2483/005; C09J 2467/006

(57) ABSTRACT

The present disclosure relates to a silicone-based coating composition, and a silicone-based release film comprising the same.

### TECHNICAL FIELD

This application claims priority to and the benefits of Korean Patent Application No. 10-2020-0090770, filed with the Korean Intellectual Property Office on Jul. 22, 2020, the entire contents of which are incorporated herein by reference.

The present specification relates to a silicone-based coating composition, and a silicone-based release film comprising the same.

### BACKGROUND ART

Flat panel displays (FPD) are widely used as a display device of various electronic and electric devices. Examples thereof include display devices such as a CRT display, a liquid crystal display, a plasma display, an organic EL display, an inorganic EL display, an LED display, a surface electrolytic display (SED) and a field emission display (FED), or touch panels using the same, and various films are attached to a surface of such displays for the purpose of preventing scratches, pollution, fingerprint adhesion, static electricity, reflection, glare and looking-in.

Among various films, a silicone-based release film is prepared in a form of coating a silicone composition as a thin film on a base. A key main role of such a silicone-based release film includes a property of coating solution wetting and a property of showing releasability, however, such two properties conflict each other, and improving wet properties for a coating solution causes a problem of affecting peel properties due to an increase in the surface energy.

Accordingly, an excellent silicone-based release film having no influence on peel properties while improving wetting properties has been required.

### PRIOR ART DOCUMENTS

### Patent Documents

Korean Patent No. 10-0377243

### DISCLOSURE

### Technical Problem

The present disclosure is directed to providing an excellent silicone-based coating composition having, by comprising a urea group-introduced silicone-based compound, no influence on peel properties while improving wetting properties of a coating layer.

The present disclosure is directed to providing a silicone-based release film comprising a coating layer, a cured material of the silicone-based coating composition.

However, problems that the present disclosure is to resolve are not limited to the problems mentioned above, and other problems that are not mentioned will be clearly understood by those skilled in the art from the following descriptions.

### Technical Solution

One embodiment of the present disclosure provides a silicone-based coating composition comprising a silicone-based resin, a silicone-based crosslinking agent and a metal catalyst, and further comprising a urea group-introduced silicone-based compound represented by the following Chemical Formula 1:

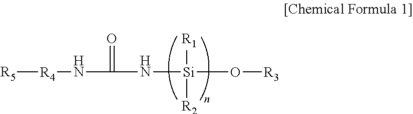

in Chemical Formula 1,

R₁ and R₂ are each independently hydrogen, a substituted or unsubstituted alkyl group, a substituted or unsubstituted alkenyl group, a substituted or unsubstituted alkynyl group, a substituted or unsubstituted cycloalkyl group, a substituted or unsubstituted cycloalkynyl group, a substituted or unsubstituted aryl group or a substituted or unsubstituted heteroaryl group,

R₃ is hydrogen, a substituted or unsubstituted alkyl group, an amino group (NH₂) or L₁-OH,

R₄ is a substituted or unsubstituted alkylene group, a substituted or unsubstituted cycloalkylene group, a substituted or unsubstituted arylene or a substituted or unsubstituted heteroarylene,

R₅ is an isocyanate group (—N═C═O), an amino group (NH₂), a substituted or unsubstituted alkyl group or a hydroxyl group (OH),

L₁ is a substituted or unsubstituted alkylene group, a substituted or unsubstituted cycloalkylene group, a substituted or unsubstituted arylene or a substituted or unsubstituted heteroarylene, and

n is an integer of 1 to 1000.

Another embodiment of the present disclosure provides a silicone-based release film comprising a base layer; and a coating layer that is a cured material of the silicone-based coating composition.

### Advantageous Effects

A silicone-based coating composition according to the present disclosure is, by further comprising a urea group-introduced silicone-based compound, is capable of maintaining favorable peel properties while having improved wetting properties of a coating layer, and accordingly, capable of providing a silicone-based release film suitable for manufacturing films used in various fields.

By having improved wetting properties and favorable peel properties, the silicone-based release film according to the present disclosure has an advantage of being suitable for manufacturing films used in various fields.

Effects of the present disclosure are not limited to the above-described effects, and effects that are not mentioned will be clearly understood by those skilled in the art from the specification and accompanying drawings of the present application.

### MODE FOR DISCLOSURE

Hereinafter, the present disclosure will be described in more detail to illuminate the present disclosure.

A silicone-based coating composition according to the present disclosure and a silicone-based release film including the same will be described hereinafter, however, unless specified otherwise, technical terms and scientific terms used herein have meanings that those having common knowledge in the art commonly understand, and in the following descriptions, descriptions on known functions and constitutions that may unnecessarily obscure the gist of the present disclosure will not be included.

Terms used in the present specification are defined as follows.

Throughout the specification of the present application, a description of a certain part “comprising” certain constituents means capable of further comprising other constituents, and does not exclude other constituents unless particularly stated on the contrary.

Throughout the specification of the present application, a description of one member being placed “on” another member includes not only a case of the one member being in contact with the another member but a case of still another member being present between the two members.

Throughout the specification of the present application, “parts by weight” may mean a weight ratio between each component.

Throughout the specification of the present application, “one or more” means, for example, “1, 2, 3, 4 or 5, particularly 1, 2, 3 or 4, more particularly 1, 2 or 3, and even more particularly 1 or 2”.

In the present disclosure, a weight average molecular weight (Mw), a number average molecular weight (Mn) and a Z average molecular weight (Mz+1) are numbers converted with respect to standard polystyrene measured using gel permeation chromatography (GPC, manufactured by Waters). However, the weight average molecular weight (Mw), the number average molecular weight (Mn) and the Z average molecular weight (Mz+1) are not limited thereto, and may be measured using other methods known in the art.

Throughout the specification of the present application, release peel strength of a coating layer may mean an average force applied to peel the coating layer measured according to a peel angle of 180° and a peel rate of 0.3 m/min using a measurement device (Cheminstruments, Inc./AR-1000) after attaching the coating layer to a Tesa7475 standard adhesive tape by pressing back and forth 3 times with a load of 2 kg, storing for a set time (1 day) at a set temperature (70° C.). Herein, Final Test Method No. 10 may be used as the measurement standard.

Throughout the specification of the present application, “substituted or unsubstituted” means being substituted with one or more substituents selected from the group consisting of deuterium; a halogen group; a cyano group; a nitrile group; a nitro group; a hydroxyl group; a carbonyl group; an ester group; an imide group; an amino group; a phosphine oxide group; an alkoxy group; a cycloalkoxy group; an aryloxy group; a heterocyclyloxy group; an alkylthioxy group; an arylthioxy group; an alkylsulfoxy group; an arylsulfoxy group; a silyl group; a carbosilyl group; a boron group; an alkyl group; a cycloalkyl group; an alkenyl group; an alkynyl group; an aryl group; an aralkyl group; an aralkenyl group; an alkylaryl group; an alkylamine group; an aralkylamine group; a heteroarylamine group; an arylamine group; an arylphosphine group; or a heteroaryl comprising one or more of N, O and S atoms, or being unsubstituted, or being substituted with a substituent linking two or more substituents among the substituents illustrated above, or being unsubstituted.

Throughout the specification of the present application, the “substituent linking two or more substituents” may be a biphenyl group. In other words, a biphenyl group may be an aryl group, or interpreted as a substituent linking two phenyl groups.

In the present specification, the term “deuterium” refers to a stable isotope of hydrogen having a mass approximately twice that of a most common isotope, that is, a mass of approximately 2 atomic mass units.

Throughout the specification of the present application, the “halogen group” refers to a fluoro (F), a chloro (Cl), a bromo (Br) or an iodo (I) atom.

In the present specification, the term “cyano group” or “nitro group” means a —C≡N group.

Throughout the specification of the present application, an “isocyanate group” means a —N≡C═O group.

Throughout the specification of the present application, the “nitro group” refers to a —NO₂ group.

Throughout the specification of the present application, the “hydroxyl group” refers to an —OH group.

Throughout the specification of the present application, the “carbonyl group” means a divalent organic radical represented by —C(═O)—. Specifically, the number of carbon atoms of the carbonyl group is not particularly limited, but is preferably from 1 to 40. Compounds having structures as below may be specifically included, however, the carbonyl group is not limited thereto.

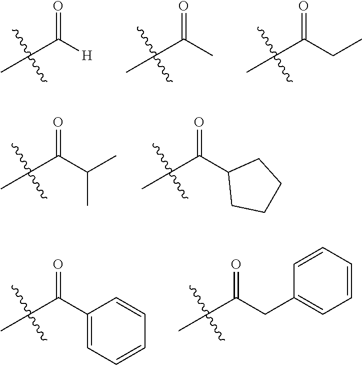

Throughout the specification of the present application, the “ester group” refers to a —C(═O)O group. Specifically, in the ester group, oxygen of the ester group may be substituted with a linear, branched or cyclic alkyl group having 1 to 25 carbon atoms or an aryl group having 6 to 25 carbon atoms. Compounds having the following structural formulae may be specifically included, however, the ester group is not limited thereto.

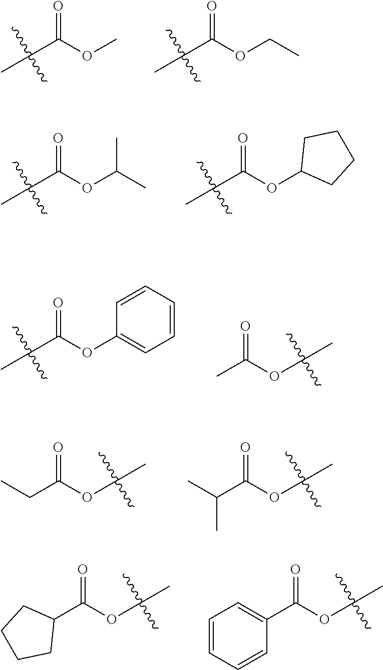

Throughout the specification of the present application, the “ether” means being represented by —R—O—R′. In the ether, R or R′ is each independently hydrogen, an alkyl group having 1 to 20 carbon atoms, an aryl group having 6 to 30 carbon atoms, a cycloalkyl group having 3 to 30 carbon atoms, an alkenyl group having 2 to 20 carbon atoms, an alkynyl group having 2 to carbon atoms, or a combination thereof, but is not limited thereto.

Throughout the specification of the present application, the “imide group” means a structure of —C(O)NR^{x}C(O)R^{y}. Specifically, R^{x} and R^{y} are each independently hydrogen, or a substituted or unsubstituted alkyl, cycloalkyl, alkenyl, alkynyl, aryl, aralkyl, heterocyclyl or heterocyclylalkyl group as defined in the present specification. Specifically, the number of carbon atoms of the imide group is not particularly limited, but is preferably from 1 to 25. Compounds having structures as below may be specifically included, however, the imide group is not limited thereto.

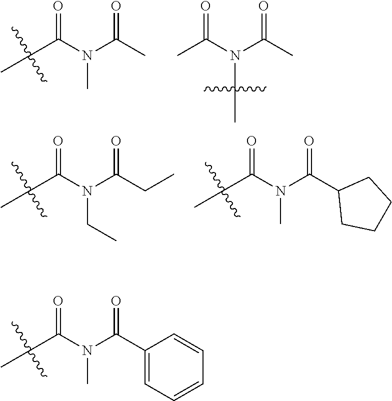

Throughout the specification of the present application, the “amino group” refers to an —NH₂ group.

Throughout the specification of the present application, the “phosphine oxide group” means a structure of —P(═O)R^{x}R^{y}R^{z}.

Throughout the specification of the present application, the “alkoxy group”, the “cycloalkoxy group”, the “aryloxy group” and the “heterocyclyloxy group” refer to any one of the alkyl, the cycloalkyl, the aryl or the heterocyclyl attached to the rest of the molecule through an oxygen atom (—O—).

Throughout the specification of the present application, the “alkylthioxy group” and the “arylthioxy group” refer to any one of the alkyl or the aryl attached to the rest of the molecule through a sulfur atom (—S—).

Throughout the specification of the present application, the “alkylsulfoxy group” and the “arylsulfoxy group” refer to any one of the alkyl or the aryl attached to the rest of the molecule through —SO.

Throughout the specification of the present application, the “carbosilyl group” means an organic silyl group comprising carbon, hydrogen and silicon and containing a Si—C bond. Specifically, the number of carbon atoms of the carbosilyl is not particularly limited, but is preferably from 1 to 10, and although the number of silyl is not particularly limited, the number of silyl is preferably from 1 to 10. Specific examples of the carbosilyl group may include, but are not limited to, methylsilyl (—SiMeH₂), ethylsilyl (—SiEtH₂), diethylsilyl (—SiEt₂H), dimethylsilyl (—SiMe₂H), triethylsilyl (—SiEt₃), trimethylsilyl (—SiMe₃), 1,2-dimethyldisilyl (—SiMeHSiMeH₂), 1,4-disilabutyl (—SiH₂CH₂CH₂SiH₃), dimethylvinylsilyl (—SiMe₂CH═CH₂), phenylsilyl (—SiPhH₂) and the like.

Throughout the specification of the present application, the “silyl group” means an unsubstituted silyl group (—SiH₃).

Specific examples of the silyl group may include a trimethylsilyl group, a triethylsilyl group, a t-butyldimethylsilyl group, a vinyldimethylsilyl group, a propyldimethylsilyl group, a triphenylsilyl group, a diphenylsilyl group, a phenylsilyl group and the like, but are not limited thereto.

Specific examples of the boron group may include a trimethylboron group, a triethylboron group, a t-butyldimethylboron group, a triphenylboron group, a phenylboron group and the like, but are not limited thereto.

Throughout the specification of the present application, the “alkyl group” means linear or branched saturated hydrocarbon. Specifically, the number of carbon atoms of the alkyl group is not particularly limited, but is preferably from 1 to 40. According to one embodiment, the number of carbon atoms of the alkyl group is from 1 to 20. According to another embodiment, the number of carbon atoms of the alkyl group is from 1 to 10. According to another embodiment, the number of carbon atoms of the alkyl group is from 1 to 6. Specific examples of the alkyl group may include methyl, ethyl, propyl, n-propyl, isopropyl, butyl, n-butyl, isobutyl, tert-butyl, sec-butyl, 1-methyl-butyl, 1-ethyl-butyl, pentyl, n-pentyl, isopentyl, neopentyl, tert-pentyl, hexyl, n-hexyl, 1-methylpentyl, 2-methylpentyl, 4-methyl-2-pentyl, 3,3-dimethylbutyl, 2-ethylbutyl, heptyl, n-heptyl, 1-methylhexyl, cyclopentylmethyl, cyclohexylmethyl, octyl, n-octyl, tert-octyl, 1-methylheptyl, 2-ethylhexyl, 2-propylpentyl, n-nonyl, 2,2-dimethylheptyl, 1-ethyl-propyl, 1,1-dimethyl-propyl, isohexyl, 2-methylpentyl, 4-methylhexyl, 5-methylhexyl and the like, but are not limited thereto.

Throughout the specification of the present application, the “cycloalkyl group” refers to a completely saturated and partially unsaturated hydrocarbon ring of carbon atoms. Specifically, the cycloalkyl group is not particularly limited, but preferably has 3 to 60 carbon atoms, and according to one embodiment, the number of carbon atoms of the cycloalkyl group is from 3 to 30. According to another embodiment, the number of carbon atoms of the cycloalkyl group is from 3 to 20. According to another embodiment, the number of carbon atoms of the cycloalkyl group is from 3 to 6. Specific examples thereof may include cyclopropyl, cyclobutyl, cyclopentyl, 3-methylcyclopentyl, 2,3-dimethylcyclopentyl, cyclohexyl, 3-methylcyclohexyl, 4-methylcyclohexyl, 2,3-dimethylcyclohexyl, 3,4,5-trimethylcyclohexyl, 4-tert-butylcyclohexyl, cycloheptyl, cyclooctyl and the like, but are not limited thereto.

Throughout the specification of the present application, the “alkenyl group” refers to linear or branched unsaturated hydrocarbon comprising one or more double bonds. Specifically, the alkenyl group may be linear or branched, and although not particularly limited thereto, the number of carbon atoms is preferably from 2 to 40. According to one embodiment, the number of carbon atoms of the alkenyl group is from 2 to 20. According to another embodiment, the number of carbon atoms of the alkenyl group is from 2 to 10. According to another embodiment, the number of carbon atoms of the alkenyl group is from 2 to 6. Specific examples thereof may include vinyl, 1-propenyl, isopropenyl, 1-butenyl, 2-butenyl, 3-butenyl, 1-pentenyl, 2-pentenyl, 3-pentenyl, 3-methyl-1-butenyl, 1,3-butadienyl, allyl, 1-phenylvinyl-1-yl, 2-phenylvinyl-1-yl, 2,2-diphenylvinyl-1-yl, 2-phenyl-2-(naphthyl-1-yl)vinyl-1-yl, 2,2-bis(diphenyl-1-yl)vinyl-1-yl, a stilbenyl group, a styrenyl group and the like, but are not limited thereto.

Throughout the specification of the present application, the “alkynyl group” means a linear or branched unsaturated hydrocarbon radical comprising one or more triple bonds. Specifically, the alkynyl group may be linear or branched, and although not particularly limited thereto, the number of carbon atoms is preferably from 2 to 40. According to one embodiment, the number of carbon atoms of the alkynyl group is from 2 to 20. According to another embodiment, the number of carbon atoms of the alkynyl group is from 2 to 10. According to another embodiment, the number of carbon atoms of the alkynyl group is from 2 to 6. Specific examples thereof may include short-chain hydrocarbon radicals selected from among ethynyl, prop-1-yn-1-yl, prop-2-yn-1-yl, but-1-yn-1-yl, but-1-yn-3-yl, but-3-yn-1-yl and the like, but are not limited thereto.

Throughout the specification of the present application, the “aryl group” means, as an organic radical derived from aromatic hydrocarbon by removing one hydrogen, a monocyclic or polycyclic aromatic hydrocarbon radical. Specifically, the aryl group is not particularly limited, but preferably has 6 to 60 carbon atoms, and may be a monocyclic aryl group or a polycyclic aryl group. According to one embodiment, the number of carbon atoms of the aryl group is from 6 to 30. According to one embodiment, the number of carbon atoms of the aryl group is from 6 to 20. When the aryl group is a monocyclic aryl group, examples thereof may include a phenyl group, a biphenyl group, a terphenyl group and the like, but are not limited thereto. When the aryl group is a polycyclic aryl group, examples thereof may include a naphthyl group, an anthracenyl group, a phenanthryl group, a pyrenyl group, a perylenyl group, a chrysenyl group, a fluorenyl group and the like, but are not limited thereto.

Throughout the specification of the present application, the “fluorenyl group” means a 9-fluorenyl radical.

Specifically, the fluorenyl group may be substituted, and two substituents may bond to each other to form a spiro structure. When the fluorenyl group is substituted,

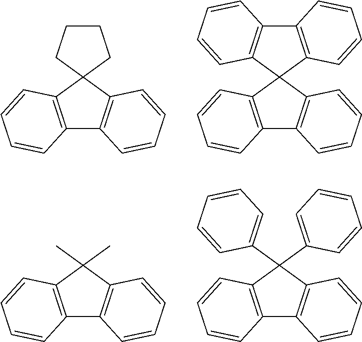

and the like may be included. However, the structure is not limited thereto.

Throughout the specification of the present application, the “heteroaryl group” means, as an organic radical derived from aromatic hydrocarbon by removing one hydrogen, a heteroaryl comprising one or more heteroatoms selected from among B, N, O, S, P(═O), Si and P. Specifically, the number of carbon atoms of the heteroaryl group is not particularly limited, but is preferably from 3 to 60. Examples of the heteroaryl group may include a thiophene group, a furan group, a pyrrole group, an imidazole group, a thiazole group, an oxazole group, an oxadiazole group, a triazole group, a pyridyl group, a bipyridyl group, a pyrimidyl group, a triazine group, a triazole group, an acridly group, a pyridazine group, a pyrazinyl group, a quinolinyl group, a quinazoline group, a quinoxalinyl group, a phthalazinyl group, a pyridopyrimidinyl group, a pyridopyrazinyl group, a pyrazinopyrazinyl group, an isoquinoline group, an indole group, a carbazole group, a benzoxazole group, a benzimidazole group, a benzothiazole group, a benzocarbazole group, a benzothiophene group, a dibenzothiophene group, a benzofuranyl group, a phenanthroline group, a thiazolyl group, an isoxazolyl group, an oxadiazolyl group, a thiadiazolyl group, a benzothiazolyl group, a phenothiazinyl group, a dibenzofuranyl group and the like, but are not limited thereto.

Throughout the specification of the present application, the aryl group in the aralkyl group, the aralkenyl group, the alkylaryl group and the arylamine group is the same as the examples of the aryl group described above. In the present specification, the alkyl group in the aralkyl group, the alkylaryl group and the alkylamine group is the same as the examples of the alkyl group described above.

Throughout the specification of the present application, the descriptions on the heteroaryl provided above may be applied to the heteroaryl in the heteroarylamine. In the present specification, the alkenyl group in the aralkenyl group is the same as the examples of the alkenyl group described above. In the present specification, the descriptions on the aryl group provided above may be applied to the arylene except that the arylene is a divalent group. In the present specification, the descriptions on the heteroaryl group provided above may be applied to the heteroarylene except that the heteroarylene is a divalent group. In the present specification, the descriptions on the aryl group or the cycloalkyl group provided above may be applied to the hydrocarbon ring except that the hydrocarbon ring is not a monovalent group and is formed through bonding of two substituents. In the present specification, the descriptions on the heteroaryl provided above may be applied to the heteroring except that the heteroring is not a monovalent group and is formed through bonding of two substituents.

Silicone-Based Coating Composition

One embodiment of the present disclosure provides a silicone-based coating composition comprising a silicone-based resin, a silicone-based crosslinking agent and a metal catalyst, and further comprising a urea group-introduced silicone-based compound represented by the following Chemical Formula 1.

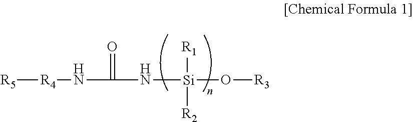

In Chemical Formula 1,

R₁ and R₂ are each independently hydrogen, a substituted or unsubstituted alkyl group, a substituted or unsubstituted alkenyl group, a substituted or unsubstituted alkynyl group, a substituted or unsubstituted cycloalkyl group, a substituted or unsubstituted cycloalkynyl group, a substituted or unsubstituted aryl group or a substituted or unsubstituted heteroaryl group,

R₃ is hydrogen, a substituted or unsubstituted alkyl group, an amino group (NH₂) or L₁-OH,

R₄ is a substituted or unsubstituted alkylene group, a substituted or unsubstituted cycloalkylene group, a substituted or unsubstituted arylene or a substituted or unsubstituted heteroarylene,

R₅ is an isocyanate group (—N═C═O), an amino group (NH₂), a substituted or unsubstituted alkyl group or a hydroxyl group (OH),

L₁ is a substituted or unsubstituted alkylene group, a substituted or unsubstituted cycloalkylene group, a substituted or unsubstituted arylene or a substituted or unsubstituted heteroarylene, and

n is an integer of 1 to 1000.

The silicone-based coating composition according to the present disclosure has suitable release peel strength while improving wet properties, and a silicone-based release film suitable for manufacturing films used in various fields may be provided. Specifically, the silicone-based release film is used in various fields such as a field of display units such as a liquid crystal display, a plasma display, a personal digital assistant and navigation, an organic light emitting diode, a polymer light emitting diode and a polarizing plate, a field of coating, a field of gluing agent and a field of adhesive, and may mean a film capable of performing a role of protecting a surface of a target article, a surface of a gluing agent, a surface of an adhesive or the like, performing a role of a carrier of a target article, or performing a role of being used as a base film for manufacturing a designated film and removed from the designated film. In addition, the silicone-based release film may mean a film attached to a target article during processes of manufacturing, transporting and storing the target article and the like, but removed when manufacturing a final article.

In the present specification, the term “silicone-based resin” means a highly crosslinked network-like polymer comprising one or more silicon (Si) atoms, particularly, one or more SiO groups. Specifically, in the present disclosure, the silicone-based resin may be vinyl terminated polydimethylsiloxane. However, types of the silicone-based resin are not limited to those described above.

According to the present disclosure, the silicone-based resin may have a poly dispersity index (PDI) of 1 to 3. The poly dispersity index is a value obtained by dividing a weight average molecular weight value by a number average molecular weight.

In the present disclosure, a weight average molecular weight (Mw), a number average molecular weight (Mn) and a Z average molecular weight (Mz+1) are numbers converted with respect to standard polystyrene measured using gel permeation chromatography (GPC, manufactured by Waters). However, the weight average molecular weight (Mw), the number average molecular weight (Mn) and the Z average molecular weight (Mz+1) are not limited thereto, and may be measured using other methods known in the art.

According to the present disclosure, the silicone-based resin may have a weight average molecular weight of greater than or equal to 100,000 g/mol and less than or equal to 600,000 g/mol. Specifically, the silicone-based resin may have a weight average molecular weight of greater than or equal to 150,000 g/mol and less than or equal to 550,000 g/mol, greater than or equal to 200,000 g/mol and less than or equal to 500,000 g/mol, or greater than or equal to 250,000 g/mol and less than or equal to 450,000 g/mol. Adjusting the weight average molecular weight of the silicone-based resin to the above-described range may effectively prevent surface energy of a coating layer comprising a cured material of the silicone-based coating composition from excessively increasing or decreasing. Furthermore, when the weight average molecular weight of the silicone-based resin is in the above-mentioned range, release peel strength of the coating layer comprising a cured material of the silicone-based coating composition may be obtained at a proper level.

In the present specification, as the “silicone-based crosslinking agent”, those used for preparing a release agent composition in the art may be employed without limit. For example, the silicone-based crosslinking agent may be a polyorganohydrogen siloxane having at least two silicon atom-bonding hydrogen atoms in one molecule, and may specifically include at least one of a dimethylhydrogensiloxy group end-capping dimethylsiloxane-methyl hydrogen siloxane copolymer, a trimethylsiloxy group end-capping dimethylsiloxane-methyl hydrogen siloxane copolymer, a trimethylsiloxy group end-capping poly(methyl hydrogen siloxane), poly(hydrogen silesquioxane) and methyl hydrogen siloxane, however, types of the silicone-based crosslinking agent are not limited. In the present disclosure, methyl hydrogen siloxane may be used as the silicone-based crosslinking agent.

According to the present disclosure, as the metal catalyst, those used in the art for preparing a silicone-based coating composition may be employed and used without limit. Specifically, the metal catalyst may at least include a platinum-based catalyst. In addition, the platinum-based catalyst may include at least one of particulate platinum, particulate platinum adsorbed on a carbon powder carrier, chloroplatinic acid, alcohol-modified chloroplatinic acid and an olefin complex of chloroplatinic acid, however, types of the platinum-based catalyst are not limited. In the present disclosure, PL-50T (ShinEtsu Silicone) may be used as the platinum-based catalyst.

According to the present disclosure, the silicone-based coating composition may have a liquid composition form.

According to the present disclosure, the silicone-based coating composition in a liquid form may include an organic solvent; a silicone-based resin; a silicone-based crosslinking agent; a metal catalyst; and the urea group-introduced silicone-based compound represented by Chemical Formula 1.

According to the present disclosure, the silicone-based coating composition in a liquid form may include, with respect to 100 parts by weight of the organic solvent, the silicone-based resin in 5 parts by weight to 30 parts by weight; the silicone-based crosslinking agent in 0.05 parts by weight to 5 parts by weight; the metal catalyst in 0.5 parts by weight to parts by weight; and the urea group-introduced silicone-based compound represented by Chemical Formula 1 in 0.1 parts by weight to 50 parts by weight.

According to the present disclosure, the organic solvent may be at least one of dimethylacetamide (DMAC), dimethylformamide (DMF), dimethyl sulfoxide (DMSO), tetrahydrofuran (THF) and acetone. However, the organic solvent is not limited thereto, and may be freely selected among organic solvents generally known in the art.

According to the present disclosure, the content of the silicone-based resin may be greater than or equal to 5 parts by weight and less than or equal to 30 parts by weight with respect to 100 parts by weight of the organic solvent. Specifically, the content of the silicone-based resin may be greater than or equal to 7.5 parts by weight and less than or equal to 25.5 parts by weight, greater than or equal to 8.5 parts by weight and less than or equal to 21.5 parts by weight, or greater than or equal to 9.5 parts by weight and less than or equal to 18.5 parts by weight with respect to 100 parts by weight of the organic solvent. By adjusting the content of the silicone-based resin to the above-described range, the silicone-based coating composition may be more readily cured. In addition, when the content of the silicone-based resin is in the above-described range, the coating layer comprising a cured material of the silicone-based coating composition may have a proper level of release peel strength while improving wet properties by increasing surface energy.

According to the present disclosure, the content of the silicone-based crosslinking agent may be greater than or equal to 0.05 parts by weight and less than or equal to 5 parts by weight with respect to 100 parts by weight of the organic solvent. Specifically, the content of the silicone-based crosslinking agent may be greater than or equal to 0.1 parts by weight and less than or equal to 3 parts by weight, greater than or equal to 0.5 parts by weight and less than or equal to 2 parts by weight, or greater than or equal to 0.8 parts by weight and less than or equal to 1.5 parts by weight with respect to 100 parts by weight of the organic solvent. Adjusting the content of the silicone-based crosslinking agent to the above-described range may effectively prevent release peel strength of the coating layer from excessively increasing. Specifically, when the content of the silicone-based crosslinking agent is within the above-described range, release peel strength of the coating layer may be suppressed from greatly increasing even when storing the silicone-based release film for a long period of time under a high temperature condition. In addition, durability of the silicone-based release film comprising a cured material of the silicone-based coating composition may be enhanced. Furthermore, the content of the silicone-based crosslinking agent being within the above-described range may prevent curability of the silicone-based coating composition from decreasing. Accordingly, the silicone-based coating composition may suppress release performance, that is, peel performance, of the coating layer from declining.

According to the present disclosure, the content of the metal catalyst may be greater than or equal to 0.5 parts by weight and less than or equal to 10 parts by weight with respect to 100 parts by weight of the organic solvent. Specifically, the content of the metal catalyst may be greater than or equal to 1 parts by weight and less than or equal to 8 parts by weight, greater than or equal to 1.5 parts by weight and less than or equal to 7 parts by weight, or greater than or equal to 2 parts by weight and less than or equal to 4 parts by weight with respect to 100 parts by weight of the organic solvent. Specifically, the metal catalyst performs a role of facilitating a curing reaction of the silicone-based resin and the silicone-based crosslinking agent, and adjusting the content of the metal catalyst to the above-described range may effectively suppress the silicone-based coating composition from being uncured or overcured.

According to the present disclosure, the content of the urea group-introduced silicone-based compound represented by Chemical Formula 1 may be greater than or equal to 0.1 parts by weight and less than or equal to 50 parts by weight with respect to 100 parts by weight of the organic solvent. Specifically, the content of the urea group-introduced silicone-based compound represented by Chemical Formula 1 may be greater than or equal to 0.3 parts by weight and less than or equal to 45 parts by weight, greater than or equal to 0.5 parts by weight and less than or equal to 40 parts by weight, or greater than or equal to 1 parts by weight and less than or equal to 30 parts by weight with respect to 100 parts by weight of the organic solvent. Specifically, by adjusting the content of the urea group-introduced silicone-based compound represented by Chemical Formula 1 to the above-described range, a proper level of release peel strength may be obtained while improving wet properties by increasing surface energy.

The urea group-introduced silicone-based compound represented by Chemical Formula 1 may be as follows:

R₁ and R₂ are each independently hydrogen or a substituted or unsubstituted alkyl group,

R₃ is hydrogen, a substituted or unsubstituted alkyl group, an amino group (NH₂) or L₁-OH,

R₄ is a substituted or unsubstituted alkylene group or a substituted or unsubstituted cycloalkylene group,

R₅ is an isocyanate group (—N═C═O),

L₁ is a substituted or unsubstituted alkylene group, and

n is an integer of 300 to 1000.

More specifically, the urea group-introduced silicone-based compound represented by Chemical Formula 1 may be represented by the following Chemical Formula 2.

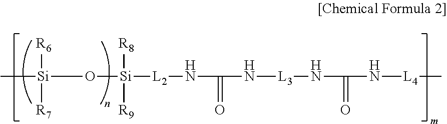

In Chemical Formula 2,

R₆ to R₉ are each independently hydrogen, a substituted or unsubstituted alkyl group, a substituted or unsubstituted alkenyl group, a substituted or unsubstituted alkynyl group, a substituted or unsubstituted cycloalkyl group, a substituted or unsubstituted cycloalkynyl group, a substituted or unsubstituted aryl group or a substituted or unsubstituted heteroaryl group,

L₂ to L₄ are each independently a substituted or unsubstituted alkylene group, a substituted or unsubstituted cycloalkylene group, a substituted or unsubstituted arylene or a substituted or unsubstituted heteroarylene,

n is an integer of 1 to 1000, and

m is an integer of 10 to 1000.

The urea group-introduced silicone-based compound represented by Chemical Formula 2 may be as follows:

R₆ to R₉ are each independently hydrogen or a substituted or unsubstituted alkyl group,

L₂ to L₄ are each independently a substituted or unsubstituted alkylene group or a substituted or unsubstituted cycloalkylene group,

n is an integer of 300 to 1000, and

m is an integer of 300 to 1000.

More specifically, the urea group-introduced silicone-based compound represented by Chemical Formula 2 may be any one of compounds of the following Chemical Formulae 2-1, 2-2, 2-3 and 2-4.

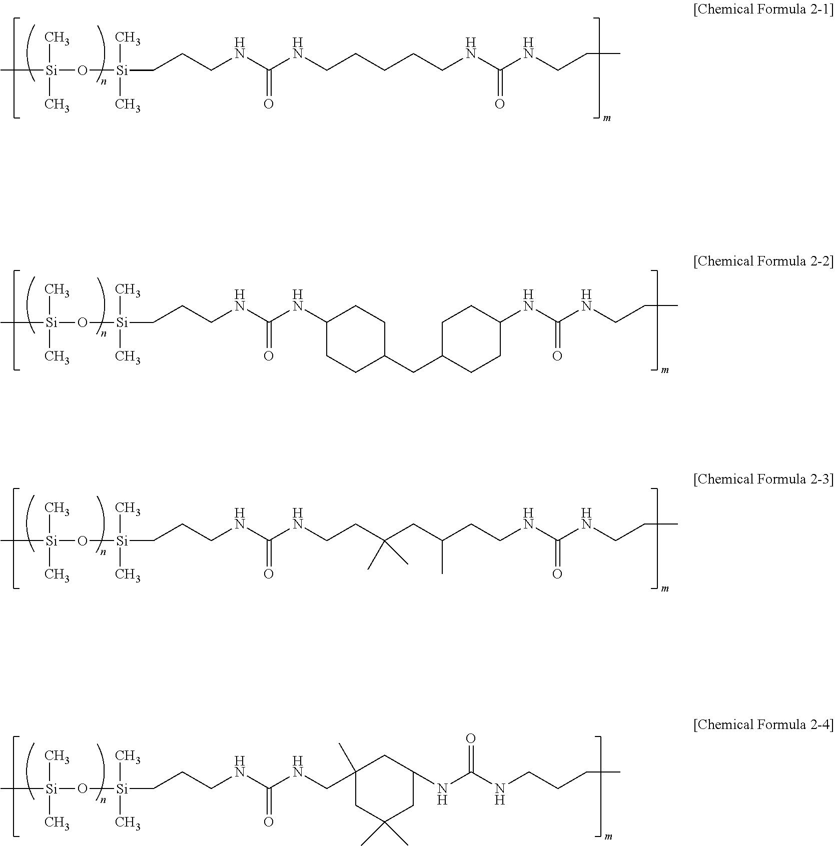

In Chemical Formulae 2-1 to 2-4,

n is an integer of 500 to 1000, and

m is an integer of 300 to 1000.

According to the present disclosure, the silicone-based coating composition may have a solid content of greater than or equal to 0.5 weight % and less than or equal to 30 weight %. Specifically, the silicone-based coating composition may have a solid content of greater than or equal to 1 weight % and less than or equal to 25 weight %, greater than or equal to 5 weight % and less than or equal to 20 weight %, greater than or equal to weight % and less than or equal to 15 weight %, greater than or equal to 1 weight % and less than or equal to 5 weight %, greater than or equal to 8 weight % and less than or equal to 15 weight %, or greater than or equal to 20 weight % and less than or equal to 28 weight %.

According to the present disclosure, the silicone-based coating composition may be readily coated by adjusting the solid content of the silicone-based coating composition to the above-described range. In addition, a sudden increase in viscosity may be prevented when curing the silicone-based coating composition, and accordingly, a decrease in wettability during the coating may be prevented. Specifically, when the solid content of the silicone-based coating composition is within the above-described range, the content of the silicone-based resin included in the silicone-based coating composition is relatively small, which may prevent a decrease in durability of the cured material of the silicone-based coating composition. In addition, a decrease in surface flatness of the cured material caused by a sudden increase in viscosity when curing the silicone-based coating composition may be effectively suppressed.

According to the present disclosure, the silicone-based coating composition may include other additives comprising at least one of a release agent, silica particles and a photoinitiator. However, types of the other additives are not limited, and known constitutions used in the art may be used.

According to one embodiment of the present disclosure, the silicone-based coating composition may be cured through photocuring or thermal curing. Specifically, the silicone-based coating composition may be thermally cured, and thermal curing of the silicone-based coating composition may be conducted for a time of longer than or equal to 30 seconds and shorter than or equal to 180 seconds at a temperature of higher than or equal to 100° C. and lower than or equal to 180° C. By adjusting the curing temperature and the curing time of the silicone-based coating composition to the above-described ranges, the silicone-based coating composition may be stably cured, and the cured material may have enhanced durability.

Silicone-Based Release Film

One embodiment of the present disclosure provides a silicone-based release film comprising a base layer; and a coating layer that is a cured material of the silicone-based coating composition.

The silicone-based release film according to the present disclosure has suitable release peel strength while greatly increasing surface energy, which is advantageous in manufacturing films used in various fields.

*130 According to the present disclosure, the silicone-based release film includes a base layer and a coating layer, and the coating layer may include a cured material of the silicone-based coating composition.

According to the present disclosure, by coating and curing the silicone-based coating composition on one surface of the base layer, a silicone-based release film comprising the coating layer provided on one surface of the base layer may be provided. As a method of coating the silicone-based coating composition on one surface of the base, known processes may be used. Specifically, an inkjet printing process, a dispensing process, a silk screen process, a spray coating process, a spin coating process, a knife coating process, a dip coater coating process, a Mayer bar coating process, a gravure coating process, a micro gravure coating process and the like may be used.

According to the present disclosure, the base layer may include at least one of a polyethylene resin, a polyethylene terephthalate resin, a polyether ether ketone resin, a polyimide resin, a polypropylene resin, an elongated polypropylene resin, cellulose and a polyvinyl chloride resin, however, types of the base layer are not limited.

According to the present disclosure, the base layer may have a thickness of greater than or equal to 10 μm and less than or equal to 500 μm. The silicone-based release film comprising the base layer having a thickness in the above-described range may have excellent durability.

According to the present disclosure, the coating layer may have a thickness of greater than or equal to 30 nm and less than or equal to 500 nm. The silicone-based release film comprising the coating layer having a thickness in the above-described range may have suitable release peel strength.

According to one embodiment of the present disclosure, the coating layer may satisfy the following Equation 1.

10%≤|(X−Y)/X|×100≤350% [Equation 1]

In Equation 1, X is release peel strength of the coating layer after attaching the coating layer to a Tesa7475 standard adhesive tape and storing for 1 day at room temperature (25° C.) (initial release peel strength), and Y means release peel strength of the coating layer after attaching the coating layer to a Tesa7475 standard adhesive tape and storing for 1 day at 70° C. (release peel strength after heat treatment).

In other words, with respect to the release peel strength of the coating layer after attaching the coating layer to a Tesa7475 standard adhesive tape and storing for 1 day at room temperature (25° C.) (initial release peel strength), an amount of change in the release peel strength of the coating layer after storing for 1 day at 70° C. (release peel strength after heat treatment) may be greater than or equal to 10% and less than or equal to 350%. Specifically, an amount of change in the release peel strength after heat treatment with respect to the initial release peel strength may be greater than or equal to 12% and less than or equal to 330%, or greater than or equal to 15% and less than or equal to 320%. Release peel strength comprising the coating layer in which the amount of change in the release peel strength after heat treatment with respect to the initial release peel strength satisfies the above-described range has an advantage of maintaining release performance at a proper level even under a high temperature condition. In other words, the silicone-based release film may be exposed to various conditions after provided in an actual product, and particularly, the silicone-based release film may have a proper level of release performance even when exposed to a high temperature condition.

According to the present disclosure, release peel strength of the coating layer may be measured at a peel angle of 180° and a peel rate of 0.3 m/min under a 50 RH % humidity condition after attaching the coating layer to a Tesa7475 standard adhesive tape, and storing the silicone-based release film for a set time at a set temperature.

According to the present disclosure, release peel strength of the coating layer after attaching the coating layer to a Tesa7475 standard adhesive tape and storing for 1 day at room temperature (25° C.) may be greater than or equal to 3 gf/in and less than or equal to 50 gf/in. The silicone-based release film comprising the coating layer having release peel strength satisfying the above-described range after storing for 1 day at room temperature (25° C.) may have a proper level of release peel strength.

According to the present disclosure, release peel strength of the coating layer after attaching the coating layer to a Tesa7475 standard adhesive tape and storing for 1 day at 70° C. may be greater than or equal to 5 gf/in and less than or equal to 300 gf/in. The silicone-based release film comprising the coating layer having release peel strength satisfying the above-described range after storing for 1 day at 70° C. has an advantage of obtaining superior release performance even under a high temperature condition.

According to the present disclosure, the coating layer may have surface energy of greater than or equal to 25 mN/m and less than or equal to 40 mN/m. The silicone-based release film may have a proper level of release peel strength while surface energy of the coating layer satisfies the above-described range.

According to one embodiment of the present disclosure, the coating layer may satisfy the following Equation 2.

85%≤A/B≤99.9% [Equation 2]

In Equation 2, A is release peel strength of the coating layer after attaching the coating layer to a Tesa7475 standard adhesive tape and storing for 1 day at room temperature (25° C.), and B means release peel strength of an adhesive tape not attached to the silicone-based release film.

In other words, with respect to the release peel strength of the adhesive tape not attached to the silicone-based release film, a residual adhesive rate of the release peel strength of the coating layer after attaching the coating layer to a Tesa7475 standard adhesive tape and storing for 1 day at room temperature (25° C.) may be greater than or equal to 85% and less than or equal to 99.9%.

Hereinafter, the present disclosure will be described in detail with reference to examples in order to specifically describe the present disclosure. However, examples according to the present disclosure may be modified to various different forms, and the scope of the present disclosure is not construed as being limited to the examples described below. Examples of the present specification are provided in order to more fully describe the present disclosure to those having average knowledge in the art.

### PREPARATION EXAMPLE: PREPARATION OF UREA GROUP-INTRODUCED SILICONE-BASED COMPOUND

### Preparation Example 1

In a THF solvent, 1 mole of aminosilicone having the following structure and 1 mole of hexamethylene diisocyanate (Asahi Kasei Corporation/HDI) were reacted for 4 hours at 20° C. to prepare a compound represented by the following Chemical Formula 2-1 (Si-HDI). Herein, nitrogen substitution was also conducted at the same time.

A weight average molecular weight of the compound represented by the following Chemical Formula 2-1 was from 150,000 g/mol to 200,000 g/mol when measured using the above-described method, and the poly dispersity index was from 1.9 to 2.0.

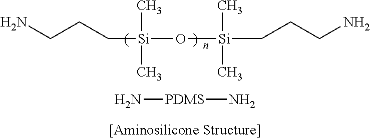

In the aminosilicone structure,

n is an integer of 500 to 1000.

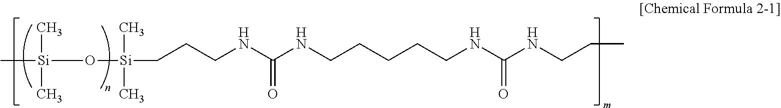

In Chemical Formula 2-1,

n is an integer of 500 to 1000, and

m is an integer of 300 to 1000.

### Preparation Example 2

In a THF solvent, 1 mole of aminosilicone having the following structure and 1 mole of 4,4′-methylene dicyclohexyl diisocyanate (Evonik Industries AG/H12-MDI) were reacted for 4 hours at 20° C. to prepare a compound represented by the following Chemical Formula 2-2 (Si-H12-MDI). Herein, nitrogen substitution was also conducted at the same time.

A weight average molecular weight of the urea group-introduced silicone-based compound represented by the following Chemical Formula 2-2 was from 100,000 g/mol to 150,000 g/mol when measured using the above-described method, and the poly dispersity index was from 1.9 to 2.0.

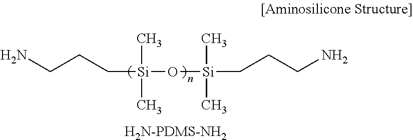

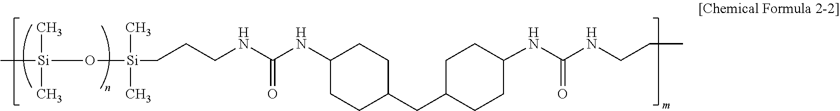

In Chemical Formula 2-2,

n is an integer of 500 to 1000, and

m is an integer of 300 to 1000.

### Preparation Example 3

In a THF solvent, 1 mole of aminosilicone having the following structure and 1 mole of trimethyl hexane diisocyanate (Evonik Industries AG/TMDI) were reacted for 4 hours at 20° C. to prepare a compound represented by the following Chemical Formula 2-3 (Si-TMDI). Herein, nitrogen substitution was also conducted at the same time.

A weight average molecular weight of the urea group-introduced silicone-based compound represented by the following Chemical Formula 2-3 was from 50,000 g/mol to 100,000 g/mol when measured using the above-described method, and the poly dispersity index was from 1.8 to 2.0.

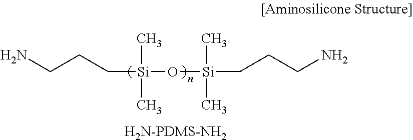

In the aminosilicone structure,

n is an integer of 500 to 1000.

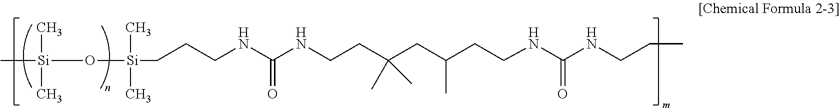

In Chemical Formula 2-3,

n is an integer of 500 to 1000, and

m is an integer of 300 to 1000.

### Preparation Example 4

In a THF solvent, 1 mole of aminosilicone having the following structure and 1 mole of isophorone diisocyanate (Evonik Industries AG/IPDI) were reacted for 4 hours at 20° C. to prepare a compound represented by the following Chemical Formula 2-4 (Si-IPDI). Herein, nitrogen substitution was also conducted at the same time.

A weight average molecular weight of the urea group-introduced silicone-based compound represented by the following Chemical Formula 2-4 was from 80,000 g/mol to 120,000 g/mol when measured using the above-described method, and the poly dispersity index was from 1.8 to 2.0.

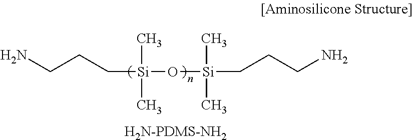

In the aminosilicone structure,

n is an integer of 500 to 1000.

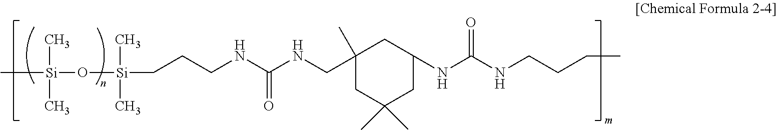

In Chemical Formula 2-4,

n is an integer of 500 to 1000, and

m is an integer of 300 to 1000.

### EXAMPLE AND COMPARATIVE EXAMPLE: PREPARATION OF SILICONE-BASED RELEASE FILM

Material Preparation

Vinyl terminated polydimethylsiloxane (Shin-Etsu Silicone/KS-847H) having a weight average molecular weight of 300,000 g/mol to 400,000 g/mol and poly dispersity index of 1.8 to 2.2 as a silicone-based resin, a silicone-based crosslinking agent (Shin-Etsu Silicone/X-92-122), a platinum-based catalyst (Shin-Etsu Silicone/PL-50T), a urea group-introduced silicone-based compound represented by each of Chemical Formulae 2-1 to 2-4 prepared according to Preparation Examples 1 to 4, and tetrahydrofuran (THF) as a solvent were prepared.

### Example 1

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 1 parts by weight of the urea group-introduced silicone-based compound represented by Chemical Formula 2-1 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Example 2

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 3 parts by weight of the urea group-introduced silicone-based compound represented by Chemical Formula 2-1 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Example 3

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 5 parts by weight of the urea group-introduced silicone-based compound represented by Chemical Formula 2-1 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Example 4

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 10 parts by weight of the urea group-introduced silicone-based compound represented by Chemical Formula 2-1 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Example 5

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 30 parts by weight of the urea group-introduced silicone-based compound represented by Chemical Formula 2-1 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Example 6

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 5 parts by weight of the urea group-introduced silicone-based compound represented by Chemical Formula 2-2 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Example 7

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 5 parts by weight of the urea group-introduced silicone-based compound represented by Chemical Formula 2-3 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Example 8

A silicone-based coating composition comprising, with respect to 100 parts by weight of the tetrahydrofuran, 10 parts by weight of the silicone-based resin, 1 parts by weight of the silicone-based crosslinking agent, 3 parts by weight of the platinum-based catalyst and 5 parts by weight of the urea group-introduced silicone-based compound represented by Chemical Formula 2-4 prepared according to Preparation Example 1 was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

TABLE 1

| Combination | | | | | | | | |
|---|---|---|---|---|---|---|---|---|
| (Parts by Weight) | Example 1 | Example 2 | Example 3 | Example 4 | Example 5 | Example 6 | Example 7 | Example 8 |
| Organic Solvent (THF) | 100 | 100 | 100 | 100 | 100 | 100 | 100 | 100 |
| Silicone-Based Resin | 10 | 10 | 10 | 10 | 10 | 10 | 10 | 10 |
| Silicone-Based Compound | 1 | 3 | 5 | 10 | 30 | 5 | 5 | 5 |
| Silicone-Based Crosslinking Agent | 1 | 1 | 1 | 1 | 1 | 1 | 1 | 1 |
| Platinum-Based Catalyst | 3 | 3 | 3 | 3 | 3 | 3 | 3 | 3 |

### [Table 1]-Summary of Compositions in Examples

### Comparative Example 1

A silicone-based coating composition comprising, with respect to 100 parts by weight of the tetrahydrofuran, 10 parts by weight of the silicone-based resin, 1 parts by weight of the silicone-based crosslinking agent and 3 parts by weight of the platinum-based catalyst was prepared.

After that, the prepared silicone-based coating composition was coated to a thickness of 2.5 g/m² on a polyethylene terephthalate (PET, MCC/T10075S) base layer having a thickness of 50 μm using a Mayer bar No. 8. After that, the silicone-based coating composition coated on the base was dried and cured for 1 minute at 130° C., and then aged for 24 hours at 50° C. to prepare a release film.

### Comparative Example 2

A non-silicone release film formed with a melamine resin (Unitika Ltd./TRZ50) was used.

### Comparative Example 3

A polyethylene terephthalate (PET, MCC/T10075S) film not treated with the silicone-based coating composition was used.

Measurement Method

For the films prepared in the examples and the comparative examples, physical properties were measured as follows.

1. Measurement of Release Peel Strength

Release peel strength of each of the release films prepared in Example 1 to Example 8 and Comparative Example 1 to Comparative Example 3 was measured as follows.

The coating layer of the release film was attached to a Tesa7475 standard adhesive tape by pressing back and forth 3 times with a load of 2 kg, stored for 1 day under the atmosphere of 25° C. and 50 RH %, and release peel strength was measured using a measurement device (Cheminstruments, Inc./AR-1000) under the atmosphere of 25° C. and 50 RH %. For the sample size of 50 mm×1,500 mm and the peel strength measurement size of 250 mm×1, 500 mm, the measurement was made at a peel angle of 180° and a peel rate of 0.3 m/min, and an average value of 5 repeated measurements was obtained to obtain the release peel strength (gf/in).

In addition, the coating layer of the silicone-based release film was attached to a Tesa7475 standard adhesive tape by pressing back and forth 3 times with a load of 2 kg, stored for 1 day under the atmosphere of 70° C. and 50 RH %, and release peel strength was measured using a measurement device (Cheminstruments, Inc./AR-1000) under the atmosphere of 25° C. and 50 RH %. For the sample size of 50 mm×1,500 mm and the peel strength measurement size of 250 mm×1,500 mm, the measurement was made at a peel angle of 180° and a peel rate of 0.3 m/min, and an average value of 5 repeated measurements was obtained to obtain the release peel strength (gf/in).

The release peel strength of the coating layer after storing for 1 day at 25° C. (initial release peel strength) measured through the above-described method, the release peel strength of the coating layer after storing for 1 day at 70° C. (release peel strength after heat treatment), and an amount of change in the release peel strength after heat treatment with respect to the initial release peel strength are shown in the following Table 2 and Table 3.

2. Measurement of Residual Adhesive Rate

A sample was prepared under the same condition as the peel strength-measured sample using an adhesive tape NITTO 31B, and left unattended for 1 day under the same condition. The adhesive tape was peeled from the release film, and pressed to a stainless plate (SUS 304) by going back and forth 2 times using a roller with a load of 2 kg, then left unattended for 30 minutes, and peel strength was measured in the same manner (A). An adhesive tape not attached to the release film was directly attached to a stainless plate, and peel strength was measured and used as a standard value (B).

For each of the samples, a residual adhesive rate (%) was obtained by calculating A/B×100 after repeated measurements of times, and the results are shown in the following Table 4 and Table 5.

3. Measurement of Surface Energy

Surface energy of each of the release films prepared in Example 1 to Example 8 and Comparative Example 1 to Comparative Example 3 was measured as follows. Ultrapure water (1 mL) and diiodomethane (1 mL), solvents for measuring surface energy, were dropped on the release film at a rate of 1 μL/s, contact angles of the solvents for measurement were measured using a measurement device (DataPhysics Instruments/OCA20), and surface energy of the release film was calculated using the same. The surface energy values measured using the above-described method are described in the following Table 6 and Table 7.

In Table 6 and Table 7, ‘Pol’ means surface energy indicating polar tendency calculated by dropping the ultrapure water on the films of the examples and the comparative examples, and ‘Dis’ means surface energy indicating nonpolar tendency calculated by dropping the diiodomethane. Total surface energy corresponds to the sum of the surface energies (Pol and Dis).

Measurement Results

TABLE 2

| | | Example 1 | Example 2 | Example 3 | Example 4 | Example 5 | Example 6 | Example 7 | Example 8 |
|---|---|---|---|---|---|---|---|---|---|
| Release Peel | Room Temperature*1 Day | 10.3 | 7.8 | 7.1 | 7.7 | 8.1 | 25.6 | 56.8 | 19.9 |
| Strength (gf/in) | 70° C.*1 Day | 12.8 | 9.2 | 8.4 | 10.1 | 8.7 | 57.8 | 235.7 | 45.1 |

### [Table 2]-Measurement Results of Release Peel Strength of Examples 1 to 8

TABLE 3

| | | Comparative | Comparative | Comparative |
|---|---|---|---|---|
| | | Example 1 | Example 2 | Example 3 |
| Release | Room | 11.7 | — | — |
| Peel | Temper- | 13.3 | | |
| Strength | ature* | | | |
| (gf/in) | 1 Day | | | |
| | 70° C. | | | |
| | *1 Day | | | |

### [Table 3]-Measurement Results of Release Peel Strength of Comparative Examples 1 to 3

TABLE 4

| | Example 1 | Example 2 | Example 3 | Example 4 | Example 5 | Example 6 | Example 7 | Example 8 |
|---|---|---|---|---|---|---|---|---|
| Residual Adhesive Rate (%) | 99.1 | 96.5 | 95.9 | 88.1 | 74.3 | 92.1 | 88.8 | 90.0 |

### [Table 4]-Measurement Results of Residual Adhesive Rate of Examples 1 to 8

TABLE 5

| | Comparative | Comparative | Comparative |
|---|---|---|---|
| | Example 1 | Example 2 | Example 3 |
| Residual | 98.6 | — | — |
| Adhesive | | | |
| Rate (%) | | | |

### [Table 5]-Measurement Results of Residual Adhesive Rate of Comparative Examples 1 to 3

TABLE 6

| | | Example 1 | Example 2 | Example 3 | Example 4 | Example 5 | Example 6 | Example 7 | Example 8 |
|---|---|---|---|---|---|---|---|---|---|
| Surface Energy | Dis | 23.01 | 25.91 | 27.44 | 28.31 | 29.54 | 23.87 | 24.10 | 26.79 |
| (mN/m) | Polar | 0.88 | 2.29 | 4.85 | 5.23 | 6.78 | 4.00 | 3.97 | 5.13 |
| | Total | 23.89 | 28.2 | 32.39 | 33.54 | 36.32 | 27.87 | 28.07 | 31.92 |

### [Table 6]-Measurement Results of Surface Energy of Examples 1 to 8

TABLE 7

| | | Comparative | Comparative | Comparative |
|---|---|---|---|---|
| | | Example 1 | Example 2 | Example 3 |
| Surface | Dis | 22.11 | 32.05 | 41.98 |
| Energy | Polar | 0.41 | 0.51 | 8.88 |
| (mN/m) | Total | 22.52 | 32.56 | 50.86 |

### [Table 7]-Measurement Results of Surface Energy of Comparative Examples 1 to 3

1. A silicone-based coating composition comprising:
a silicone-based resin;
a silicone-based crosslinking agent; and
a metal catalyst, and further comprising,
a urea group-introduced silicone-based compound represented by the following Chemical Formula 1: 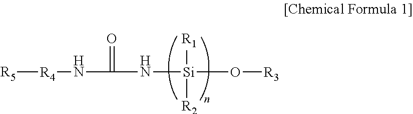
wherein, in Chemical Formula 1,
R₁ and R₂ are each independently hydrogen, a substituted or unsubstituted alkyl group, a substituted or unsubstituted alkenyl group, a substituted or unsubstituted alkynyl group, a substituted or unsubstituted cycloalkyl group, a substituted or unsubstituted cycloalkynyl group, a substituted or unsubstituted aryl group or a substituted or unsubstituted heteroaryl group;
R₃ is hydrogen, a substituted or unsubstituted alkyl group, an amino group (NH₂) or L₁-OH;
R₄ is a substituted or unsubstituted alkylene group, a substituted or unsubstituted cycloalkylene group, a substituted or unsubstituted arylene or a substituted or unsubstituted heteroarylene;
R₅ is an isocyanate group (—N═C═O), an amino group (NH₂), a substituted or unsubstituted alkyl group or a hydroxyl group (OH);
L₁ is a substituted or unsubstituted alkylene group, a substituted or unsubstituted cycloalkylene group, a substituted or unsubstituted arylene or a substituted or unsubstituted heteroarylene; and
n is an integer of 1 to 1000.

2. The silicone-based coating composition of claim 1, wherein the silicone-based resin is vinyl terminated polydimethylsiloxane.

3. The silicone-based coating composition of claim 1, wherein the urea group-introduced silicone-based compound represented by Chemical Formula 1 is as follows:
R₁ and R₂ are each independently hydrogen or a substituted or unsubstituted alkyl group;
R₃ is hydrogen, a substituted or unsubstituted alkyl group, an amino group (NH₂) or L₁-OH;
R₄ is a substituted or unsubstituted alkylene group or a substituted or unsubstituted cycloalkylene group;
R₅ is an isocyanate group (—N═C═O);
L₁ is a substituted or unsubstituted alkylene group; and
n is an integer of 300 to 1000.

4. The silicone-based coating composition of claim 1, which has a form of a liquid composition.

5. The silicone-based coating composition of claim 4, comprising:
an organic solvent;
a silicone-based resin;
a silicone-based crosslinking agent;
a metal catalyst; and
the urea group-introduced silicone-based compound represented by Chemical Formula 1.

6. The silicone-based coating composition of claim 5, comprising:
the silicone-based resin in 5 parts by weight to 30 parts by weight;
the silicone-based crosslinking agent in 0.05 parts by weight to 5 parts by weight;
the metal catalyst in 0.5 parts by weight to 10 parts by weight; and
the urea group-introduced silicone-based compound represented by Chemical Formula 1 in 0.1 parts by weight to 50 parts by weight,
with respect to 100 parts by weight of the organic solvent.

7. The silicone-based coating composition of claim 5, wherein the organic solvent is any one of dimethylacetamide (DMAC), dimethylformamide (DMF), dimethyl sulfoxide (DMSO), tetrahydrofuran (THF) and acetone.

8. A silicone-based release film comprising:
a base layer; and
a coating layer that is a cured material of the silicone-based coating composition of claim 1.

9. The silicone-based release film of claim 8, wherein the coating layer has surface energy of 15 mN/m to 40 mN/m.

10. The silicone-based release film of claim 8, wherein the coating layer has a thickness of 30 nm to 500 nm.

11. The silicone-based release film of claim 8, wherein the base layer has a thickness of 10 μm to 500 μm.

12. The silicone-based release film of claim 8, wherein the base layer includes one selected from the group consisting of a polyethylene resin, polyethylene terephthalate resin, polyether ether ketone, paper and combinations thereof.
